(19) United States
(12) Patent Application Publication
(10) Pub. No.: US 2009/0300339 A1
(43) Pub. Date: Dec. 3, 2009

(54) LSI FOR IC CARD

(76) Inventor: Kazunori Kado, Osaka (JP)

Correspondence Address: MCDERMOTT WILL & EMERY LLP, 600 13TH STREET, NW, WASHINGTON, DC, 20005-3096, US

(21) Appl. No.: 12/063,008

(22) PCT Filed: Jul. 11, 2006
(86) PCT No.: PCT/JP2006/313736

§ 371 Date: Feb. 5, 2008

(30) Foreign Application Priority Data
Aug. 15, 2005 (JP) 2005-235218

(51) Int. Cl. G06F 9/30

(52) U.S. Cl. 712/234; 712/E09.016

(57) ABSTRACT

To prevent exposure or tampering of data by an illegal access to a memory of an LSI, a ROM (13) has two separate program regions corresponding to memory access authorities. Only when detecting a branch instruction generating signal from a CPU (12), an address decoding circuit (23) decodes a branch destination address. A mode setting circuit (24) determines to which of the program regions of the ROM (13) the decoded branch destination address corresponds, and sets the mode signal to a corresponding mode. An access control circuit (26) controls accesses to the respective memories (13, 14, 15) according to the mode signal set by the mode setting circuit (24).

### TECHNICAL FIELD

The present invention relates to an LSI for use in an IC card and specifically to a security-improved LSI for IC card which has access control over a memory storing security data.

### BACKGROUND ART

IC cards are applicable to a variety of uses, including electronic tickets, credit cards, etc. Recently, contactless IC cards have been widely used.

A typical LSI for IC card includes a ROM containing applications and operation control programs, an SRAM for temporarily storing data produced during operation, and a nonvolatile memory capable of holding data after powered off. These memories store private information, financial information, etc., and thus ensuring the security of such information is a great technical challenge.

Patent Document 1 discloses a data protecting function which is realized by determining whether data access is allowed or not according to a combination of the location of a data access instruction and the location of access data.

Patent Document 2 discloses an LSI for IC card wherein the value of a program counter is monitored for the purpose of inhibiting an illegal memory access via execution of a user program.

Patent Document 1: Japanese Laid-Open Patent Publication No. 9-160831

Patent Document 2: Japanese Laid-Open Patent Publication No. 2000-76135

### DISCLOSURE OF INVENTION

### Problems to be solved by the invention

Conventionally, there has been a possibility of exposure or tampering of security data stored in a memory by probing to a memory during an LSI operation or an operation analysis via a fraudulent operation of LSI. This means that data is not kept secure.

An objective of the present invention is to provide an LSI for IC card capable of ensuring access control of a memory even if a program should be tampered with, such that security data is protected.

### Means for Solving the Problems

To achieve the above objective, there is provided an LSI for IC card according to the present invention, which includes a memory block including a ROM which has a plurality of program regions respectively corresponding to access authorities and a CPU having a function of outputting a branch instruction generating signal for execution of a branch instruction, wherein the branch instruction generating signal from the CPU is detected to decode a branch destination address, a mode signal is set based on to which of the plurality of program regions the decoded branch destination address corresponds, and an access to the memory block is controlled with an access authority corresponding to the mode signal. Namely, the memory access control is realized by using the branch instruction generating signal output from the CPU before the CPU starts execution of a branch destination instruction, i.e., before the branch destination address enters a program counter of the CPU.

According to the present invention, execution of an instruction in a program region with a lower access authority via an instruction in a program region with a higher access authority is allowed only when the execution is carried out via a specific instruction in the higher access authority program region. In execution of the specific instruction in the higher access authority program region, the CPU sets an access requester identifier indicative of to which of the plurality of program regions of the ROM an instruction by an access requester corresponds. If the access requester identifier indicates executing an instruction in the lower access authority program region via the specific instruction, the mode setting circuit sets the mode signal according to a program region of an access requester indicated by the access requester identifier irrespective of the branch destination address decoded by the address decoding circuit.

### EFFECTS OF THE INVENTION

According to the present invention, access control of a memory is ensured even if a program should be tampered with, so that security data is protected.

### BRIEF DESCRIPTION OF DRAWINGS

FIG. 1 is a block diagram showing an example of the structure of an LSI for IC card according to the present invention.

FIG. 2 illustrates the concept of an access control method employed in the LSI for IC card shown in FIG. 1.

### DESCRIPTION OF REFERENCE NUMERALS

11 LSI
12 CPU
13 ROM
14 SRAM
15 nonvolatile memory
16 logic section
23 address decoding circuit
24 mode setting circuit
26 access control circuit
27 access requester identifier
50 memory block
AB address bus
DB data bus

### BEST MODE FOR CARRYING OUT THE INVENTION

Hereinafter, an embodiment of the present invention is described with reference to the drawings.

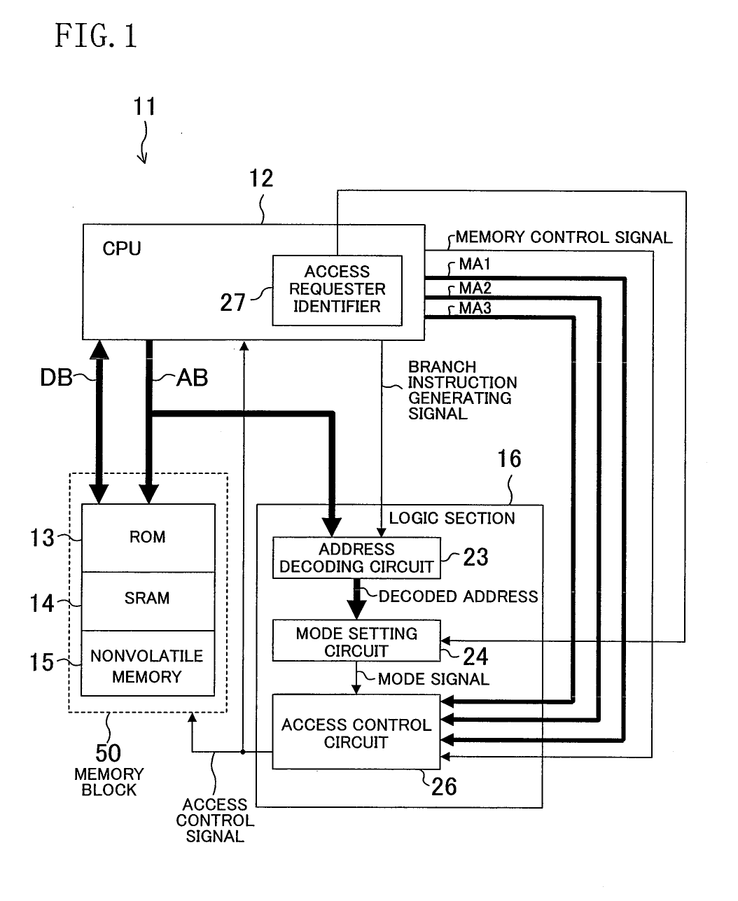

FIG. 1 shows an example of the structure of an LSI for IC card according to the present invention. The LSI 11 for IC card of FIG. 1 includes a CPU 12, a logic section 16 and a memory block 50. The memory block 50 includes a ROM 13, an SRAM 14 and a nonvolatile memory 15. Access addresses to these memories are denoted by MA1, MA2 and MA3, respectively. The logic section 16 includes an address decoding circuit 23, a mode setting circuit 24 and an access control circuit 26. The CPU 12 includes an access requester identifier 27. Arrows AB and DB denote address bus and data bus, respectively. When applied to a contactless IC card, the LSI 11 further includes an RF circuit for contactless communication.

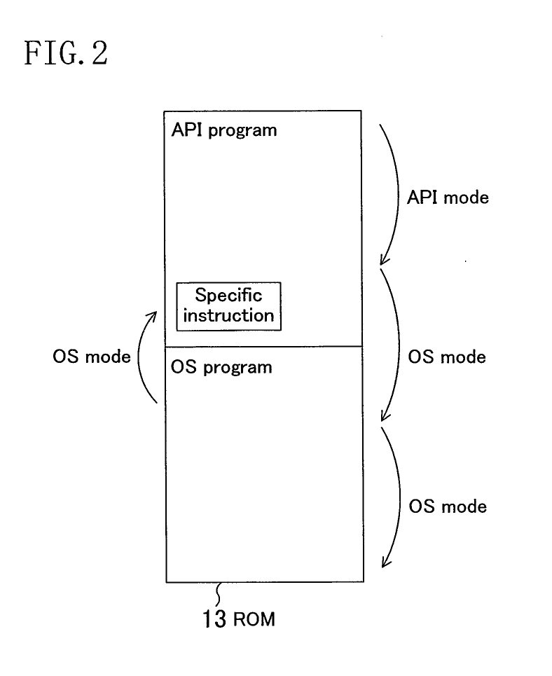

An access control method employed in the LSI 11 of FIG. 1 is described with reference to FIG. 2. Referring to FIG. 2, the ROM 13 has separate regions corresponding to the memory access authorities, including an API program region with a higher memory access authority containing API (Application Program Interface) programs, such as libraries, and the like, and an OS program region with a lower memory access authority containing card OS, such as applications, and the like.

The operation of the LSI 11 has two scenarios: (1) branching to the API program region or OS program region occurs after execution of an instruction of the API program region; and (2) branching to the API program region or OS program region occurs after execution of an instruction of the OS program region. The CPU 12 outputs a branch instruction generating signal for execution of a branch instruction. The logic section 16 detects the branch instruction generating signal, and the address decoding circuit 23 decodes a branch destination address. The timing of address decoding is determined only by the branch instruction generating signal from the CPU 12, such that the increase in circuit area of the logic section 16 is suppressed. Then, the mode setting circuit 24 determines to which of the API program region and the OS program region of the ROM 13 the branch destination address decoded by the address decoding circuit 23 corresponds, and sets the mode signal. The access control circuit 26 controls accesses to the ROM 13, the SRAM 14 and the nonvolatile memory 15, with access authorities corresponding to the respective modes, based on the set mode signal and the memory control signal and memory addresses MA1 to MA3 from the CPU 12.

The address decoding circuit 23, in which the timing of address decoding is determined by the branch instruction generating signal from the CPU 12, and the mode setting circuit 24, which carries out mode setting based on the decoded address, are thus realized by hardware. This improves the process speed of the LSI 11 and ensures access control of the respective memories 13, 14 and 15, so that the respective memory data can be always kept secure.

FIG. 2 further illustrates mode setting where OS program executes an instruction via API program. An instruction stored in the OS program region which has the lower access authority can be executed via a specific instruction stored in the API program region which has the higher access authority. In the case where the OS program having the lower access authority executes an instruction via the API program having the higher access authority, the access requester identifier 27 of the CPU 12 is set to “Request from OS Program”. When the specific instruction of the API program region is executed, the mode setting circuit 24 determines, based on the access requester identifier 27, whether the execution of the specific instruction is via an instruction of the OS program region or via an instruction of the API program region, and carries out the mode setting according to the access requester.

The destination of branching from the OS program with the lower access authority to the API program with the higher access authority is thus limited to the specific instruction. This prevents spoofing of the mode signal and enables setting of the access requester identifier 27 as intended even when a program of the OS program region storing applications and the like is tampered with. Therefore, the mode setting circuit 24 is capable of surely setting the mode signal to a corresponding mode. Hence, the access control circuit 26 is enabled to control accesses to the respective memories 13, 14 and 15 according to the mode set by the mode setting circuit 24, so that data of the respective memories can be kept secure.

As described above, the access control of the memory block 50 is realized by hardware, wherein the access control of the respective memories 13, 14 and 15 is ensured even when a program is tampered with, and the operation of the LSI 11 is stopped in case of an illegal access. With this structure, the security data stored in the respective memories 13, 14 and 15 are always kept secure.

Even where the ROM 13 has three or more program regions corresponding to access authorities and execution of an instruction is carried out via more than one of the program regions, desired access control can be realized by using the access requester identifier 27 set by the CPU 12.

### INDUSTRIAL APPLICABILITY

As described above, an LSI for IC card according to the present invention has such a structure that data stored in memories can be protected against external illegal accesses and is therefore useful as an LSI incorporated in an IC card which stores security data, such as private information, financial information, etc.

1. An LSI for IC card, comprising:
a memory block including a ROM which has a plurality of program regions respectively corresponding to access authorities;
a CPU having a function of executing an instruction stored in the ROM and a function of outputting a branch instruction generating signal for execution of a branch instruction;
an address decoding circuit which detects the branch instruction generating signal from the CPU to decode a branch destination address;
a mode setting circuit for setting a mode signal based on to which of the plurality of program regions the branch destination address decoded by the address decoding circuit corresponds; and
an access control circuit for controlling an access to the memory block with an access authority corresponding to the mode signal.

2. The LSI for IC card of claim 1, wherein:
the CPU further includes a function of setting, in execution of a specific instruction in a program region with a higher access authority, an access requester identifier indicative of to which of the plurality of program regions an instruction by an access requester corresponds; and
if the access requester identifier indicates executing an instruction in a program region with a lower access authority via the specific instruction, the mode setting circuit sets the mode signal according to a program region of an access requester indicated by the access requester identifier irrespective of the branch destination address decoded by the address decoding circuit.
